(19) United States
(12) Patent Application Publication
(10) Pub. No.: US 2026/0268539 A1
(43) Pub. Date: Sep. 10, 2026

(54) COLOR ADJUSTMENT FOR VEHICLE AUGMENTED REALITY DISPLAYS

(71) Applicant: GM GLOBAL TECHNOLOGY OPERATIONS LLC, Detroit, MI (US)

(72) Inventors: Manoj Kumar SHARMA, Troy, MI (US); Kamran Ali, Troy, MI (US); Donald K. Grimm, Utica, MI (US); Fahim Ahmed, Troy, MI (US)

(21) Appl. No.: 19/070,854

(22) Filed: Mar. 5, 2025

(51) Int. Cl. G06T 11/00; B60K 35/234; B60K 35/235; G02B 27/01; G06F 3/01; G06V 10/70; G06V 20/58

(52) U.S. Cl. CPC G06T 11/10; B60K 35/234; B60K 35/235; G06F 3/012; G06F 3/013; G06V 10/70; G06V 20/58; B60K 2360/177; B60K 2360/188; B60K 2360/21; B60K 2360/741; G02B 27/0101; G02B 2027/0138; G02B 2027/014; G06T 2210/12

(57) ABSTRACT

An example system for color adjustment of an augmented reality vehicle display includes a vehicle windshield, a display interface configured to display images on the windshield, a front vehicle camera configured to obtain an image, and a vehicle control module configured to access the image, process the image to determine an object of interest in the image, supply the image to a trained machine learning model to generate a color selection output according to at least one background color or object color identified in image, wherein the color selection output indicates a specified color which contrasts the at least one background color or object color with respect to viewing by a driver, and display an object identifier on the windshield according to a gaze direction of the driver, via the display interface, wherein the object identifier includes the color selection output from the trained machine learning model.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to color adjustment for vehicle augmented reality (AR) displays, including adjusting colors of displayed images of a heads-up display (HUD) based on detected background colors.

Some vehicles include augmented reality (AR) heads-up displays (HUD) for displaying graphics in a field of view of a driver, such as on a windshield of the vehicle. Graphics may be displayed on the AR-HUD (or AR-hybrid HUD) to attract a driver's attention and help the driver track a threat or object of interest. However, background colors, such as buildings or landscape features in further out in the driver's field of view, may reduce a contrast between the object of interest shown in graphics displayed on the AR-HUD and the colors of background objects.

### SUMMARY

An example system for color adjustment of an augmented reality vehicle display includes a windshield of a vehicle, a display interface configured to display images on the windshield, a front vehicle camera configured to obtain an image, and a vehicle control module configured to access the image from the front vehicle camera, process the image to determine an object of interest in the image, supply the image to a trained machine learning model to generate a color selection output according to at least one background color or object color identified in image, wherein the color selection output indicates a specified color which contrasts the at least one background color or object color with respect to viewing by a driver, and display an object identifier on the windshield according to a gaze direction of the driver, via the display interface, wherein the object identifier includes the color selection output from the trained machine learning model.

In some examples, the display interface includes a projector, and displaying the object identifier includes projecting the object identifier on the windshield as an augmented reality heads-up display.

In some examples, the display interface includes multiple micro light emitting diodes embedded in or adjacent the windshield, and displaying the object identifier includes displaying the object identifier on the windshield via the multiple micro light emitting diodes.

In some examples, the system includes an orientation sensor configured to detect a gaze direction of at least one of eyes of the driver of the vehicle or a head of the driver of the vehicle, wherein the vehicle control module is configured to determine the gaze direction of the driver via the orientation sensor.

In some examples, the orientation sensor includes a gaze tracker camera configured to track at least one of eye movements of the driver and head movements of the driver.

In some examples, the vehicle control module is configured to capture an image of a color check pattern with the front vehicle camera, calculate specified color vectors using the image of the color check pattern, determine a minimized difference between different color vectors, and calculate a color mapping matrix according to the minimized difference between different color vectors.

In some examples, the object identifier displayed on the windshield includes a bounding box surrounding at least a portion of the object of interest in a field of view of the driver.

In some examples, the vehicle control module is configured to fill in a portion of the bounding box with the color selection output, while leaving the object of interest visible in a center of the bounding box.

In some examples, displaying the object identifier includes displaying the object identifier on the windshield during a first time period, and the vehicle control module is configured to subsequent to the first time period, access a second image from the front vehicle camera, supply the second image to a trained machine learning model to generate a second color selection output according to at least one background color or object color identified in the second image, and update color of the object identifier on the windshield, via the display interface, in response to the second color selection output being different than a previous color selection output.

In some examples, the trained machine learning model is trained according to multiple input vectors, at least a portion of the multiple input vectors include a defined color contrast ratio between two different colors, and the defined color contrast ratio is calculated according to a relative luminance of a lighter one of the two different colors, a relative luminance of a darker one of the two different colors, and a constant weight value corresponding to a contribution of ambient light to relative luminance values for the two different colors.

An example method of adjusting color for an augmented reality vehicle display includes accessing an image from a front vehicle camera of a vehicle, processing the image to determine an object of interest in the image, supplying the image to a trained machine learning model to generate a color selection output according to at least one background color or object color identified in image, wherein the color selection output indicates a specified color which contrasts the at least one background color or object color with respect to viewing by a driver of the vehicle, and displaying an object identifier on a windshield of the vehicle according to a gaze direction of the driver, via a display interface configured to display images on the windshield, wherein the object identifier includes the color selection output from the trained machine learning model.

In some examples, the display interface includes a projector, and displaying the object identifier includes projecting the object identifier on the windshield as an augmented reality heads-up display.

In some examples, the display interface includes multiple micro light emitting diodes embedded in or adjacent the windshield, and displaying the object identifier includes displaying the object identifier on the windshield via the multiple micro light emitting diodes.

In some examples, the method includes determining a gaze direction of a driver of the vehicle via an orientation sensor configured to detect a gaze direction of at least one of eyes of the driver or a head of the driver of the vehicle.

In some examples, the method includes capturing an image of a color check pattern with the front vehicle camera, calculating specified color vectors using the image of the color check pattern, determining a minimized difference between different color vectors, and calculating a color mapping matrix according to the minimized difference between different color vectors.

In some examples, the object identifier displayed on the windshield includes a bounding box surrounding at least a portion of the object of interest in a field of view of the driver.

In some examples, displaying includes filling in a portion of the bounding box with the color selection output, while leaving the object of interest visible in a center of the bounding box.

In some examples, displaying the object identifier includes displaying the object identifier on the windshield during a first time period, and the method further comprises subsequent to the first time period, detecting the gaze direction of at least one of eyes of the driver of the vehicle or a head of the driver of the vehicle, accessing a second image from the front vehicle camera, supplying the second image to a trained machine learning model to generate a second color selection output according to at least one background color or object color identified in the second image, and updating color of the object identifier on the windshield, via the display interface, in response to the second color selection output being different than a previous color selection output.

In some examples, the method includes training the trained machine learning model according to multiple input vectors, wherein at least a portion of the multiple input vectors include a defined color contrast ratio between two different colors, and the defined color contrast ratio is calculated according to a relative luminance of a lighter one of the two different colors, a relative luminance of a darker one of the two different colors, and a constant weight value corresponding to a contribution of ambient light to relative luminance values for the two different colors.

An example method of adjusting color for an augmented reality vehicle display includes processing an image from a vehicle camera of a vehicle to determine an object of interest in the image, in response to a color vision deficient driver setting being active, applying daltonization color correction to determine a color selection output, wherein the color selection output indicates a specified color which contrasts at least one background color or object color identified in the image with respect to viewing by a driver of the vehicle, and displaying an object identifier on a windshield of the vehicle according to a gaze direction of the driver, via a display projector of an augmented reality heads-up display of the vehicle, wherein the object identifier includes the daltonization color correction.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram of an example vehicle including a vehicle control module for color adjustment of vehicle augmented reality displays.

FIG. 2 is a flowchart depicting an example process for calibrating color outputs of a vehicle camera of the vehicle of FIG. 1.

FIG. 3 is a block diagram illustrating example components of an augmented reality heads-up display of the vehicle of FIG. 1.

FIG. 4 is a flowchart depicting an example process for highlighting detected objects in an augmented reality heads-up display of a vehicle.

FIG. 5 is a flowchart depicting an example process for color adjustment of vehicle augmented reality displays.

FIGS. 6A and 6B are illustrations of example object identifiers for highlighting detected objects in vehicle augmented reality displays.

FIGS. 7A and 7B are graphical representations of example neural networks for generating color selection outputs for color adjustment of vehicle augmented reality displays.

FIG. 8 is a flowchart illustrating an example process for training a machine learning model.

In the drawings, reference numbers may be reused to identify similar and/or identical elements.

### DETAILED DESCRIPTION

Some example embodiments described herein may include systems and methods for enhancing capabilities of a vehicle augmented reality heads-up display (AR-HUD) or AR-hybrid-HUD, such as images projected onto a windshield of the vehicle in a field of view of a driver while the driver is observing the road and travel direction of the vehicle. In some implementations, a vehicle control module may be configured to assess environment colors using a color-mapped red-green-blue (RGB) front vehicle camera, for example, and then modify a color augmentation strategy for better perception using background color information from a color mapping matrix, and driver vision information.

Example methods and systems may include access environment colors using a color-mapped RGB camera, for example, and using a machine learning model to identify a color of AR graphics (such as an object identifier corresponding to a detected object of interest in an image), to align with the determined background color to make visibility of the AR graphics easier for the driver.

In some examples, the color adjustment to contrast with detected background colors may be modified according to whether the driver has normal vision, or color deficient vision. For example, if a driver color deficient vision setting is active, colors of the AR graphics may be modified to make them more visible based on the color deficiency of the driver.

In situations where a color of the AR graphics is similar to or matches background colors (e.g., building objects, landscape colors, etc. in a field of view of the driver), it is likely that the driver may miss the AR graphics. In some examples described herein, a vehicle control module may detect situations where the background color may reduce the contrast of the object of interest in AR graphics so they become less effective in attracting a driver's attention, and the vehicle control module may modify graphics to mitigate this issue.

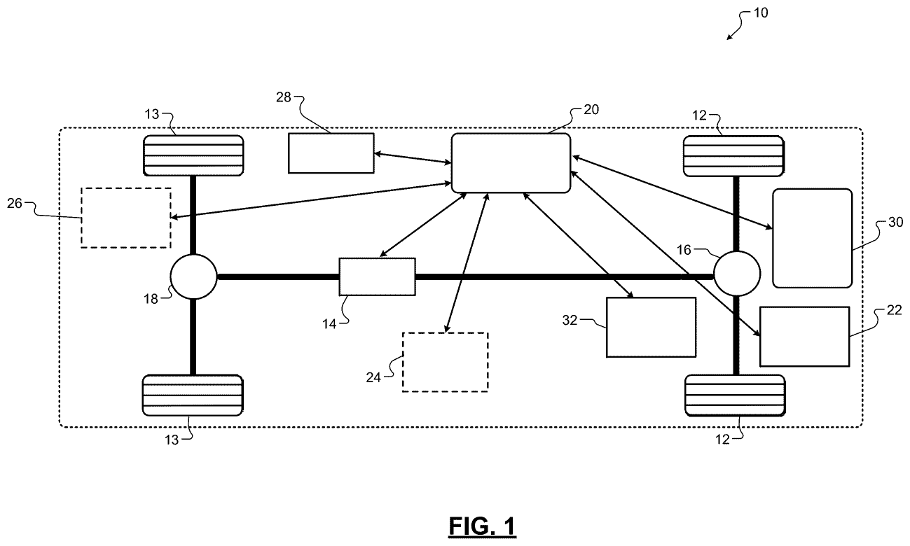

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration pedal, a brake pedal, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current height and/or position of one or more wheels, etc.

In the example of FIG. 1, the vehicle 10 includes a front vehicle camera 22, an optional side vehicle camera 24, and an optional rear vehicle camera 26. Each camera may include any suitable camera hardware components, image processing capabilities, etc., to capture images of surroundings of the vehicle, such as road features, other vehicles, etc. In some examples, images from vehicle cameras may be used for object detection, automated driving, lane determination, etc. Other example embodiments may include more or less cameras, or cameras at other positions on the vehicle 10. Other systems such as Lidar may be used to determine images or information about the surrounding environment of the vehicle.

Images captured by the front vehicle camera 22 may be used to identify objects of interest to a driver, such as road signs, pedestrians, traffic signs, other vehicles on the road, etc. A display interface 30 may be configured to display graphics or images on an AR-HUD, such as images projected onto a windshield of the vehicle 10 or micro light-emitting diodes positioned adjacent or within the windshield.

An orientation sensor 32 may be used to determine a viewing direction of the driver, such as by tracking movements of the driver's eyes or head using one or more cameras. The determined viewing direction of the driver may be used to identify a location on the windshield to display AR graphics, such as a location to display an object identifier bounding box so it appears to surround a detected object of interest out on the road as the driver looks through the windshield.

The vehicle control module 20 may communicate with another device via a wireless communication interface 28, which may include one or more wireless antennas for transmitting and/or receiving wireless communication signals. For example, the wireless communication interface 28 may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface 28 may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

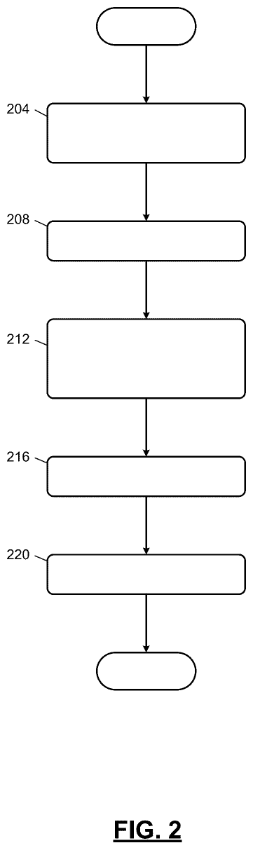

FIG. 2 is a flowchart depicting an example process for calibrating color outputs of a vehicle camera of the vehicle of FIG. 1. In some examples, the process of FIG. 2 may be implemented by the vehicle control module 20 of FIG. 1. The process begins at 204, by capturing an image of a color checker pattern using a front vehicle camera.

At 208, the vehicle control module is configured to calculate CIEXYZ vectors for the captured image. The vehicle control module then formulates an optimization problem at 212, to minimize the difference between RGB and XYZ vectors. At 216, control executes an algorithm for the RGB and XYZ vectors, and then calculates a mapping matrix M based on the algorithm at 220.

In some examples, the front vehicle camera calibration is used to determine a transformation matrix M, which maps data from a linear camera RGB to XYZ. In order to determine the transformation matrix M, a picture of a calibrated target, such as a color checker pattern, may be taken. A least-squares regression may be performed on the difference between the camera's RGB digital counts from each color checker patch, and their corresponding true XYZ values.

The camera calibration may be implemented to get correct XYZ values for images captured by different cameras, due to manufacturing tolerances, different types of front vehicle cameras that may be used, etc. In some examples, a digital X-rite color checker may be used with the front vehicle camera, to see what colors are being represented as an output of the captured camera image, compared to each color of the calibration check pattern. This may be executed at least once before the vehicle is deployed (e.g., a one-time calibration), to generate a mapping from the camera to true XYZ colors.

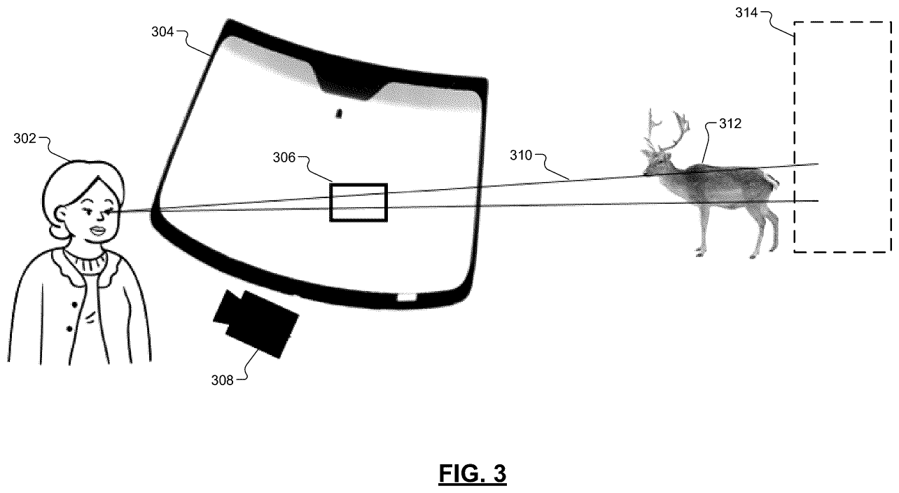

FIG. 3 is a block diagram illustrating example components of an augmented reality heads-up display of the vehicle of FIG. 1. As shown in the example of FIG. 3, a driver 302 looks though a windshield 304 while driving. The windshield 304 may include an AR heads-up display, which projects images on the windshield 304.

For example, an orientation sensor 308, such as an eye/gaze tracker, may detect movements of the head or eyes of the driver, to predict a gaze direction 310 of the driver. Any eye tracker may track head position over time, such as a location between the driver's eyes, to estimate a direction in which the driver is looking. If an image from a front vehicle camera is processed to identify an object of interest 312, such as a deer in FIG. 3 for example, the AR heads-up display may display an object identifier 306 on the windshield, corresponding to the object of interest 312.

As shown in FIG. 3, the object identifier 306 is displayed as a bounding box on the windshield 304 at a location in the gaze direction 310, such that the bounding box should surround the object of interest 312 in the driver's field of view. There are also objects in the background behind the object of interest 312, which are represented as background object color 314 in FIG. 3.

If a color of the object identifier 306 is similar to the background object color 314, it may be difficult for the driver to distinguish the projected object identifier 306 compared to the background object color 314. In some example embodiments, based on the position of the object of interest 312, the vehicle location, and the gaze direction 310 of the driver, the vehicle control module may be configured to use a color mapped RGB image to find the background object color 314.

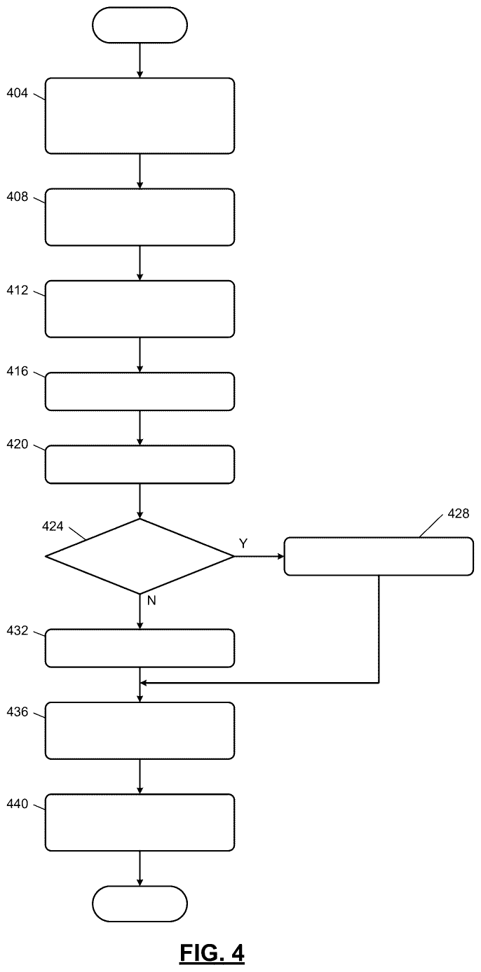

FIG. 4 is a flowchart depicting an example process for highlighting detected objects in an augmented reality heads-up display of a vehicle. In some examples, the process of FIG. 4 may be implemented by the vehicle control module 20 of FIG. 1. The process begins at 404, by using an object detection model to retrieve bounding box coordinates for detected objects.

At 408, the vehicle control module is configured to extract pixel values from edges around the bounding box. At 412, control collects pixels from the top edge, bottom edge, left edge and right edge of the bounding box. Control then computes an average color of the sampled edge pixels at 416.

At 420, the vehicle control module is configured to compare the brightness of the average background color to a specified threshold. An example formula for the brightness (luminance) may be brightness =0.299×R+0.587×G+0.114×B. If the brightness is greater than a threshold (e.g., a value of 128) at 424, control selects a dark contrasting color at 428. If the brightness is lower at 424, control selects a light contrasting color at 432.

At 436, control draws a bounding box around the detected object using the selected contrasting color. Control may then add a semi-transparent background behind the label, and overlay text for readability.

In some example embodiments, a color contrast ratio between two colors may be defined, such as (L1+0.05)/(L2+0.05), where L1 is the relative luminance of a lighter one of the two compared colors and L2 is a relative luminance of the darker one of the two colors. The 0.05 value may be configurable to other values, and may represent a constant used to weigh the contribution from ambient light to the measurements of L1 and L2.

In some examples, the relative luminance values may range from 0 (darkest black) to 1 (lightest white). This formula may provide a contrast ratio ranging from 1:1 (no contrast) to 21:1 (maximum contrast). The relative luminance of a color from sRGB color space values may be defined as L=0.2126*R+0.7152*G+0.0722*B.

In various implementations, a trained neural network may take RGB camera images as inputs, and classify the object and the background images and their colors. For example, a neural network may be trained to determine which display colors would provide a best contrast to other colors in the background scene.

Once the neural network (or other suitable machine learning model) is trained, the vehicle control module may provide images captured by the front vehicle camera to the trained model in real-time, and the model outputs a best color for highlighting objects on the display (e.g., based on identifying the background color and a color of the detected object of interest).

The network may then predict which augmentation color provides the best contrast with respect to the background. The display (e.g., a HUD, a full-windshield HUD etc.) controller may then augment colors using the color predicted by the neural network.

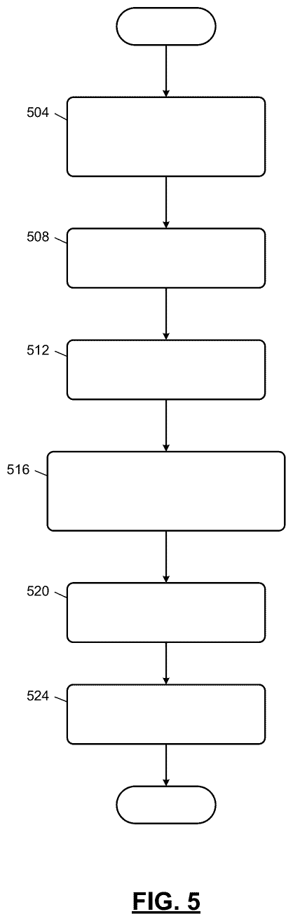

FIG. 5 is a flowchart depicting an example process for color adjustment of vehicle augmented reality displays. In some examples, the process of FIG. 5 may be implemented by the vehicle control module 20 of FIG. 1. The process begins at 504, by detecting an object of interest in a front vehicle camera image. This may be implemented using a deep learning object detection model.

At 508, the vehicle control module is configured to extract an average background color around the detected object. At 512, control determines a dominant color of the object of interest (such as a red stop sign). Control then determines, at 516, a color which contrasts to the average background color and/or dominant color of the object of interest, using a trained neural network model.

At 520, the vehicle control module is configured to draw a bounding box on an augmented reality HUD of the vehicle windshield, using the determined contrasting color. Control may then superimpose a bounding box with the adjusted color on the original image, at 524.

The augmentation color may be periodically checked and changed/updated as the vehicle moves along the road, and the background changes with respect to the driver view. For example, if green trees are behind a detected object of interest, a red bounding box may be displayed around the object of interest. If the vehicle moves forward and a red building becomes the background behind the object of interest due to vehicle movement and a new location for the driver, the bounding box may change to a non-red color, such as white or blue, to avoid blending in with the red building background color.

In some examples, different optional transitions between colors may be used, such as a gradual change once the background color changes, an immediate switch as soon as a new background color is identified, etc. In various implementations, if the system detects that the driver has looked at the displayed bounding box graphic, the system may avoid changing the bounding box color even if the background color changes, or remove the bounding box altogether, to avoid confusing the driver of whether a new object or the same object is being identified by the new color.

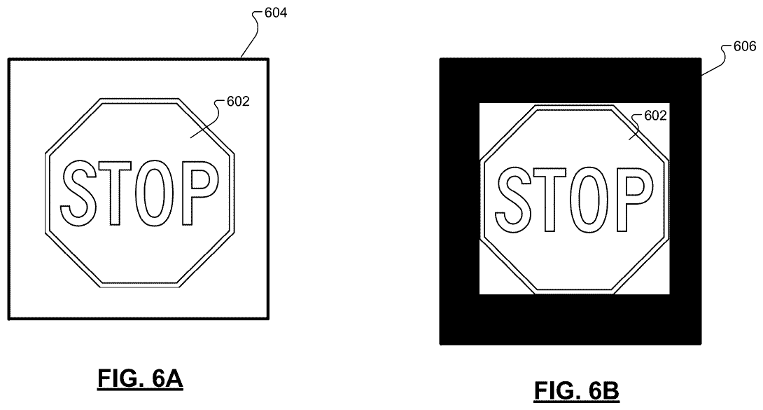

FIGS. 6A and 6B are illustrations of example object identifier images for highlighting detected objects in vehicle augmented reality displays. FIG. 6A illustrates an identified target object 602, which is a stop sign in this example. A bounding box line 604 is drawn around the identified target object 602.

In the example of FIG. 6A, the stop sign represents a physical object on the road, which the driver can view by looking through the windshield. The bounding box line 604 represents a graphic image which may be displayed on an AR HUD of the vehicle, such as by projecting the bounding box line 604 on the windshield of the vehicle.

FIG. 6B illustrates a partially filled bounding box 606, which includes an object window for viewing the identified target object 602. For example, in addition to the outline of the bounding box, the display may be modified to fill in space within the bounding box on the AR HUD of the vehicle, while leaving open a window to allow viewing of the identified target object 602 through the windshield.

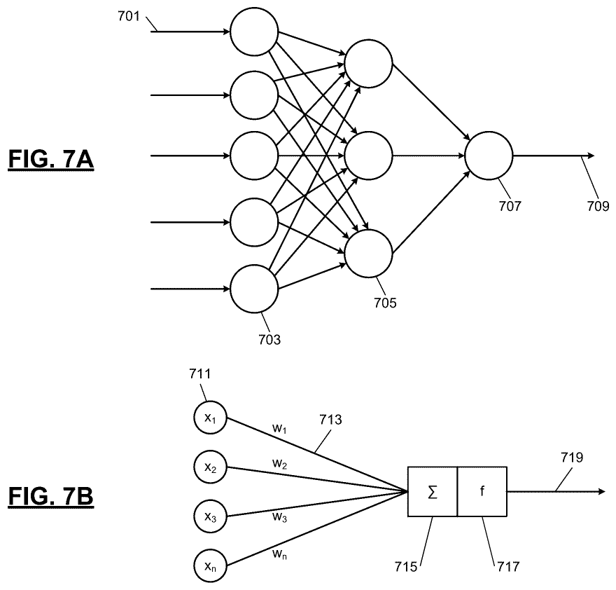

FIGS. 7A and 7B show an example of a neural network (e.g., a convolutional neural network such as YOLO) used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer 703 and receives raw input data 701. Each successive layer modifies outputs from a preceding layer and sends them to a next layer. The last layer is the output layer 707 and produces output 709 of the system.

FIG. 7A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 7B). In the input layer, the number of neurons equals the number of features (columns) in a dataset. The output layer may have multiple continuous outputs.

The layers between the input layers 703 and output layers 707 are hidden layers 705. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure the performance of a neural network model. For example, a YOLO model may measure performance using any suitable metrics such as Confidence Score, Intersection over Union (IoU), and Mean Average Precision (mAP). Confidence Score measures the model's certainty for each detected object class. IoU evaluates how well the predicted bounding box overlaps with the ground truth. Mean Average Precision (mAP) aggregates precision scores across classes.

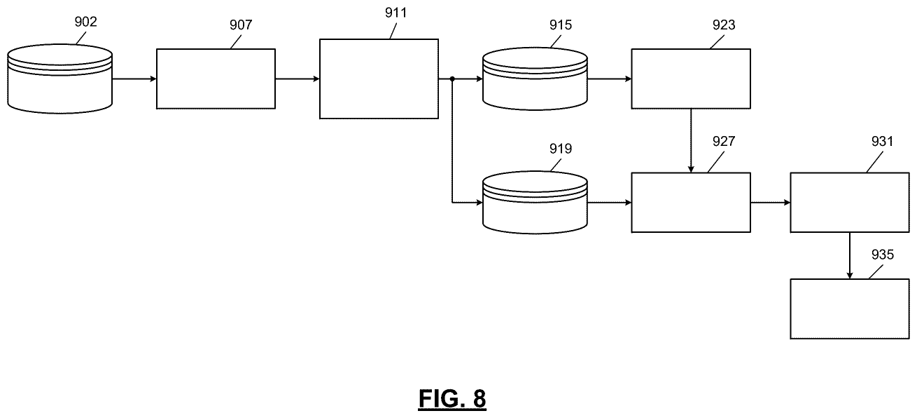

FIG. 8 illustrates an example process for generating a machine learning model. At 907, control obtains data from a database 902 (e.g., a data warehouse). The data may include any suitable data for developing machine learning models.

At 911, control separates the data obtained from the database 902 into training data 915 and test data 919. In various implementations, training of the model may be performed prior to loading the model to the vehicle, and not inside the vehicle or any of the vehicle components. The training data 915 is used to train the model at 923, and the test data 919 is used to test the model at 927. Typically, the set of training data 915 is selected to be larger than the set of test data 919, depending on the desired model development parameters. For example, the training data 915 may include about seventy percent of the data acquired from the database 902, about eighty percent of the data, about ninety percent, etc. The remaining thirty percent, twenty percent, or ten percent, is then used as the test data 919.

Separating a portion of the acquired data as test data 919 allows for testing of the trained model against actual output data, to facilitate more accurate training and development of the model at 923 and 927. The model may be trained at 923 using any suitable machine learning model techniques, including those described herein, such as random forest, generalized linear models, decision tree, and neural networks.

At 931, control evaluates the model test results. For example, the trained model may be tested at 927 using the test data 919, and the results of the output data from the tested model may be compared to actual outputs of the test data 919, to determine a level of accuracy. The model results may be evaluated using any suitable machine learning model analysis, such as the example techniques described further below.

After evaluating the model test results at 931, the model may be deployed at 935 if the model test results are satisfactory. Deploying the model may include using the model to make predictions for a large-scale input dataset with unknown outputs. If the evaluation of the model test results at 931 is unsatisfactory, the model may be developed further using different parameters, using different modeling techniques, using other model types, etc. The machine learning model method of FIG. 9 can receive inputs, e.g., vectors, which can be used to generate models that can be used, for example, to predict color section outputs to create contrasts between highlighted object identifiers of a vehicle augmented reality heads-up display, and background colors in the driver's field of view.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A system for color adjustment of an augmented reality vehicle display, the system comprising:
a windshield of a vehicle;
a display interface configured to display images on the windshield;
a front vehicle camera configured to obtain an image; and
a vehicle control module configured to:
access the image from the front vehicle camera;
process the image to determine an object of interest in the image;
supply the image to a trained machine learning model to generate a color selection output according to at least one background color or object color identified in image, wherein the color selection output indicates a specified color which contrasts the at least one background color or object color with respect to viewing by a driver; and
display an object identifier on the windshield according to a gaze direction of the driver, via the display interface, wherein the object identifier includes the color selection output from the trained machine learning model.

2. The system of claim 1, wherein:
the display interface includes a projector; and
displaying the object identifier includes projecting the object identifier on the windshield as an augmented reality heads-up display.

3. The system of claim 1, wherein:
the display interface includes multiple micro light emitting diodes embedded in or adjacent the windshield; and
displaying the object identifier includes displaying the object identifier on the windshield via the multiple micro light emitting diodes.

4. The system of claim 1, further comprising an orientation sensor configured to detect a gaze direction of at least one of eyes of the driver of the vehicle or a head of the driver of the vehicle, wherein the vehicle control module is configured to determine the gaze direction of the driver via the orientation sensor.

5. The system of claim 4, wherein the orientation sensor includes a gaze tracker camera configured to track at least one of eye movements of the driver and head movements of the driver.

6. The system of claim 1, wherein the vehicle control module is configured to:
capture an image of a color check pattern with the front vehicle camera;
calculate specified color vectors using the image of the color check pattern;
determine a minimized difference between different color vectors; and
calculate a color mapping matrix according to the minimized difference between different color vectors.

7. The system of claim 1, wherein the object identifier displayed on the windshield includes a bounding box surrounding at least a portion of the object of interest in a field of view of the driver.

8. The system of claim 7, wherein the vehicle control module is configured to fill in a portion of the bounding box with the color selection output, while leaving the object of interest visible in a center of the bounding box.

9. The system of claim 1, wherein displaying the object identifier includes displaying the object identifier on the windshield during a first time period, and the vehicle control module is configured to:
subsequent to the first time period, access a second image from the front vehicle camera;
supply the second image to a trained machine learning model to generate a second color selection output according to at least one background color or object color identified in the second image; and
update color of the object identifier on the windshield, via the display interface, in response to the second color selection output being different than a previous color selection output.

10. The system of claim 1, wherein:
the trained machine learning model is trained according to multiple input vectors;
at least a portion of the multiple input vectors include a defined color contrast ratio between two different colors; and
the defined color contrast ratio is calculated according to a relative luminance of a lighter one of the two different colors, a relative luminance of a darker one of the two different colors, and a constant weight value corresponding to a contribution of ambient light to relative luminance values for the two different colors.

11. A method of adjusting color for an augmented reality vehicle display, the method comprising:
accessing an image from a front vehicle camera of a vehicle;
processing the image to determine an object of interest in the image;
supplying the image to a trained machine learning model to generate a color selection output according to at least one background color or object color identified in image, wherein the color selection output indicates a specified color which contrasts the at least one background color or object color with respect to viewing by a driver of the vehicle; and
displaying an object identifier on a windshield of the vehicle according to a gaze direction of the driver, via a display interface configured to display images on the windshield, wherein the object identifier includes the color selection output from the trained machine learning model.

12. The method of claim 11, wherein:
the display interface includes a projector; and
displaying the object identifier includes projecting the object identifier on the windshield as an augmented reality heads-up display.

13. The method of claim 11, wherein:
the display interface includes multiple micro light emitting diodes embedded in or adjacent the windshield; and
displaying the object identifier includes displaying the object identifier on the windshield via the multiple micro light emitting diodes.

14. The method of claim 11, further comprising determining a gaze direction of a driver of the vehicle via an orientation sensor configured to detect a gaze direction of at least one of eyes of the driver or a head of the driver of the vehicle.

15. The method of claim 11, further comprising:
capturing an image of a color check pattern with the front vehicle camera;
calculating specified color vectors using the image of the color check pattern;
determining a minimized difference between different color vectors; and
calculating a color mapping matrix according to the minimized difference between different color vectors.

16. The method of claim 11, wherein the object identifier displayed on the windshield includes a bounding box surrounding at least a portion of the object of interest in a field of view of the driver.

17. The method of claim 16, wherein displaying includes filling in a portion of the bounding box with the color selection output, while leaving the object of interest visible in a center of the bounding box.

18. The method of claim 11, wherein displaying the object identifier includes displaying the object identifier on the windshield during a first time period, and the method further comprises:
subsequent to the first time period, detecting the gaze direction of at least one of eyes of the driver of the vehicle or a head of the driver of the vehicle;
accessing a second image from the front vehicle camera;
supplying the second image to a trained machine learning model to generate a second color selection output according to at least one background color or object color identified in the second image; and
updating color of the object identifier on the windshield, via the display interface, in response to the second color selection output being different than a previous color selection output.

19. The method of claim 11, further comprising training the trained machine learning model according to multiple input vectors, wherein:
at least a portion of the multiple input vectors include a defined color contrast ratio between two different colors; and
the defined color contrast ratio is calculated according to a relative luminance of a lighter one of the two different colors, a relative luminance of a darker one of the two different colors, and a constant weight value corresponding to a contribution of ambient light to relative luminance values for the two different colors.

20. A method of adjusting color for an augmented reality vehicle display, the method comprising:
processing an image from a vehicle camera of a vehicle to determine an object of interest in the image;
in response to a color vision deficient driver setting being active, applying daltonization color correction to determine a color selection output, wherein the color selection output indicates a specified color which contrasts at least one background color or object color identified in the image with respect to viewing by a driver of the vehicle; and
displaying an object identifier on a windshield of the vehicle according to a gaze direction of the driver, via a display projector of an augmented reality heads-up display of the vehicle, wherein the object identifier includes the daltonization color correction.
